(19) United States
(12) Patent Application Publication
(10) Pub. No.: US 2008/0055080 A1
(43) Pub. Date: Mar. 6, 2008

(54) Oscillator coil geometry for radio frequency metal detectors

(76) Inventor: Andrew Michael Britton, Burton on Trent (GB)

Correspondence Address: David George Johnson, Post Office Box 286, Aitkin, MN, 56431, US

(21) Appl. No.: 11/491,046

(22) Filed: Jul. 21, 2006

(51) Int. Cl. G08B 13/24; G01V 3/08

(52) U.S. Cl. 340/551; 324/326

(57) ABSTRACT

A metal detector (1) used for identifying contaminants (35) in products (35). The detector (1) includes an oscillator coil assembly (10) that may be formed as a combination of pairs of series wound coils (15, 18) and pairs of parallel wound coils (16, 17). A pair of input coils (13, 14) defines the boundaries of a region (39) within which the oscillator coil assembly (10) resides. A first signal (8) is generated by the first input coil (13) in response to the presence of a metallic object (35) while a second signal (24) is generated by the second input coil (14) in response to the presence of the metallic object (35). By measuring the ratio of the first signal (8) to the second signal (24) the physical location of a metal object within the metal detector cavity (7) can be determined.

### BACKGROUND OF THE INVENTION

1. Field of Invention

This invention pertains generally to the field of radio frequency metal detection, and more particularly to improving the flux density of the magnetic field used in such a device.

2. Description of Prior Art

Metal detectors are used in the food processing industry, for example, to detect contaminants within a product. The unwanted material may include very small metallic particles having differing compositions. The typical metal detector is housed in an enclosure containing a longitudinal aperture through which the product under test is transported, usually by means of a conveyor belt. The metal detector includes a radio frequency transducer or oscillator that radiates a magnetic field by means of some arrangement of coils that serve as a radio frequency antenna.

The typical metal detector includes a search head which contains both radiating and receiving coils, the search head being formed to surround the aperture or passageway through which the product travels. The oscillator coil is a continuous wire loop formed within the search head. The oscillator coil surrounds the aperture and receives radio frequency excitation from an oscillator circuit. The search head also includes an input coil connected to produce a zero input signal when no metal is present. A disturbance in the radiated magnetic field is sensed by the input coil and processed in order to detect a metal contaminant within the product passing through the detector aperture. A nonzero input coil signal is due to either mechanical imbalances in the construction of the search head, inherent electrical changes in the circuitry such as frequency drift, metal being introduced into the aperture, or the effect of the product itself.

Modem digital signal processing techniques resolve the input signal into two signal components, one component being resistive and the other signal component being reactive. The “product effect” caused by the product passing through the aperture is due primarily to electrical conduction via salt water within the product, the electrical conduction causing large magnitude resistive signals and relatively smaller reactive signals.

When a metal detector is used in the food processing industry, the detector is typically placed at a location which is a part of the existing food processing line. Due to constraints in processing the food items, there is often little discretion in choosing where the detector will reside. The detector is often placed in close proximity to other metal objects, such as conduits, casings, cabinets and other metal fixtures. Equipment, such as pumps and conveyors can vibrate or move with respect to the fixed position of the metal detector. The magnitude of the effect of such equipment on the metal detector is dependent on the size of the detector aperture, the detector operating frequency, the magnitude of the operating current, the type of material being tested and the size and location of any surrounding equipment which may include other metal detectors.

In many situations, the magnitude of external interference is sufficient to cause the metal detector to falsely indicate the presence of metal in the product under test. In order to provide some measure of electromagnetic shielding, the detector enclosure is usually constructed of metal, but this typically requires that the coils be separated some distance from the walls of the metal enclosure in order to minimize the effects caused by enclosure vibration, heating and aging. Vibration caused by relative movement of the enclosure with respect to the coils causes a disturbance in the radiated electromagnetic field that may easily be mistaken as the sensing of contaminant metal. The magnitude of a vibration related disturbance increases as the distance between the coils and the metallic enclosure walls is reduced. In general, any metal residing within or near the detection aperture is likely to be sensed as a contaminant particle or object even when the metal is part of the detector structure or enclosure. A method of canceling or accounting for such residual or nearby metal is a major challenge affecting the design of metal detection equipment.

Within the metal detector aperture is an area which may be properly termed as the detection zone. The detection zone is a region in which the product is subjected to the peak magnetic radiation of the oscillator coil and any disturbance in the magnetic field is assumed to be attributable to the presence of unwanted metal contaminants. Unfortunately, since the magnetic field extends beyond the detection zone, there is an additional region in which no metal should reside, typically referred to as the “metal free zone”. In real world metal detector installations, the desired metal free zone is often several times larger than the volume of the detector aperture.

Achieving a substantial metal free zone often creates problems in a food processing or other production environment. One method of reducing the volume of the metal free zone is to reduce the physical boundaries or extent of the magnetic field produced by the oscillator coil. An example of a device which employs this technique is disclosed in U.S. Pat. No. 5,572,121, entitled METAL DETECTOR INCLUDING A METAL SCREENING FOR PRODUCING A SECONDARY MAGNETIC FIELD TO REDUCE THE METAL FREE ZONE, issued on Nov. 5, 1996 to Beswick. The Beswick device places a metal screen or grid adjacent to the oscillator coil. The metal screen induces a secondary magnetic field which is in opposition to the primary magnetic field, thereby constricting the size of the primary magnetic field and the volume of the metal free zone. The Beswick forms a continuous shield around the inside of the aperture such that the starting and ending edges of the screen are electrically connected.

Ideally, the magnetic flux density created by the oscillator coil should be as large as possible but without enlarging the size of the metal free zone. A high density magnetic field must be created in a physically small volume. A larger flux density increases the magnitude of current induced in the receive coil and thus increases sensitivity to small contaminants. In an effort to address the problems presented by prior devices, the novel approach disclosed in the present invention utilizes multiple oscillator coils.

Prior efforts to utilize multiple coils have been attempted. For example, U.S. Pat. No. 5,504,428, entitled MAGNETIC METAL DETECTOR MOUNTED IN A FEED ROLL OF A HARRISTING MACHINE, issued to Johnson, discloses a single oscillator coil with multiple input coils. Johnson does not disclose multiple interconnected oscillator coils. U.S. Pat. No. 5,199,545, entitled METAL BODY DISCRIMINATING APPARATUS, issued to Takamisawa et al., discloses multiple adjacent oscillator coils that are physically parallel but which are not electrically interconnected in either a parallel or series relationship. Rather, the Takamisawa et al. coils reside individually in discrete electrical circuits. U.S. Pat. No. 6,342,835, entitled SENSOR PANEL AND A DETECTION APPARATUS INCORPORATING THE SAME, issued to Nelson-White, discloses adjacent coils in a detector that having an aperture that is large enough to accommodate a human being and which is inherently unsuitable for detecting minute metallic particles passing rapidly through a small aperture. None of the foregoing patents address the problem of specific coil geometries that may be used to enhance flux densities in a small physical space while performing a high speed signal analysis of the materials passing near the coils.

### SUMMARY OF THE INVENTION

The current invention relates to improvements in the function of a metal detector and includes techniques for improving the magnetic flux associated with the use of search heads which must be dimensioned primarily based on the aperture needed for a particular metal detection application. One embodiment of the present invention uses two oscillator coils connected in a parallel relationship to generate up to twice the magnetic flux density for a given excitation voltage whenever a relatively larger search head is required.

In the case of a small search head, the inductance is necessarily smaller due to the smaller size. In this circumstance, a given voltage will result in a relatively high current. The current is typically so high, in fact, that the voltage must be reduced to prevent the coil current from exceeding a value that would cause signal distortion, thereby raising the background noise level and hence reducing detector performance. An alternate embodiment of the present invention uses two oscillator coils interconnected in a series relationship so as to produce approximately twice the magnetic flux density for a given excitation voltage whenever a relatively smaller search head is required.

The present invention includes an input coil formed as two coils that are coaxial with the oscillator coil. The resultant three-coil arrangement is connected such that a zero net input voltage is produced under quiescent conditions.

The present invention also includes two additional types of coil arrangements that tend to increase the magnetic flux in the search head and thereby increase the signal strength in the receiving coils for any given size of metal contaminant. Search heads are presented that combine a single oscillator coil with coils that are connected in series and with coils that are connected in a parallel electrical relationship.

For example, a search head of intermediate dimensions is formed with a single oscillator coil supplemented by two series interconnected coils spaced relatively close to the input coil windings. Both the single coil and the two series coils are excited by the same voltage source or, in an alternate embodiment, by two separate sources having different voltage levels.

In other embodiments of the present invention, relatively larger search heads a combination of both series interconnected and parallel interconnected can be used together to increase received signal levels. Relatively smaller search heads can be enhanced by the use. of multiple sets of series interconnected coils.

All of the techniques of the present invention together produce cumulative improvements in the resultant metal detecting apparatus. For example, the use of a series coil arrangement in conjunction with a relatively smaller search headcan reduce the size of the smallest detectable contaminant. Typically this means that a detector previously capable of detecting a particle having a diameter of 0.8 mm will be able to detect a particle having a diameter of 0.6 mm. The ability to ignore the effects of case vibration permits greater sensitivity. This further reduces the diameter of detectable contaminants from 0.8 mm to approximately 0.4 mm.

### BRIEF DESCRIPTION OF THE DRAWINGS

FIG. 1 is a perspective view of the aperture structure of a metal detector constructed according to the principles of the present invention;

FIG. 2 is a perspective view of a metal detector incorporating the aperture structure depicted in FIG. 1;

FIG. 3 is a perspective view of a coil arrangement utilized in a first embodiment of the metal detector depicted in FIG. 2;

FIG. 4 is a perspective view of a coil arrangement utilized in a second embodiment of the present invention;

FIG. 5 is a simplified perspective view of the oscillator coil arrangement utilized in a third embodiment of the present invention;

FIG. 6 is a sectional view taken along line 6-6 of FIG. 3;

FIG. 7 is a sectional view taken along line 7-7 of FIG. 4;

FIG. 8 is a sectional view taken along line 8-8 of FIG. 5;

FIG. 9 is a graph depicting the relationship of the signals produced by the metal detector illustrated in FIG. 2;

FIG. 10 is a simplified perspective view of an oscillator coil arrangement utilized in a fourth embodiment of the metal detector depicted in FIG. 2.

### DETAILED DESCRIPTION OF THE PREFERRED EMBODIMENTS

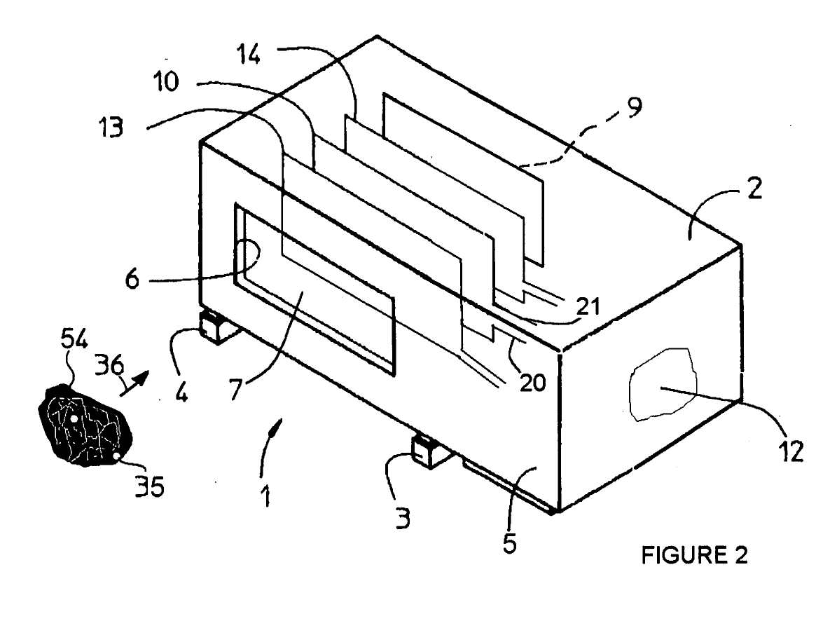

Referring to FIG. 2, a metal detector constructed according to the principles of the present invention is shown generally at 1. The metal detector 1 includes a metal or conductive cabinet 2, typically stainless steel or aluminum that is supported by shock absorbing feet 3 and 4. The cabinet is formed to include a generally rectangular first sidewall 5. The sidewall 5 includes an opening or first aperture 6 which permits access to the interior volume of cavity 7. The cavity 7 is bounded by a coaxially aligned second aperture 9, such that an article 54 may enter the cavity 7 through first aperture 6 and exit cavity 7 through the second aperture 9. The article may enter the cavity 7 by traveling generally in the direction of arrow 36 via a conveyor which may be a belt or chain as well as gravity feed mechanism or a pump forwarding the article through a conduit. In an alternate embodiment the aperture may have a circular shape, and the entire cabinet may also be generally circular or toroidal in configuration. In yet another embodiment the metal detector can be formed to have an open aperture, such as is commonly used in the carpet industry; in which the metal detector has a single sensitive face in which the active components are embedded.

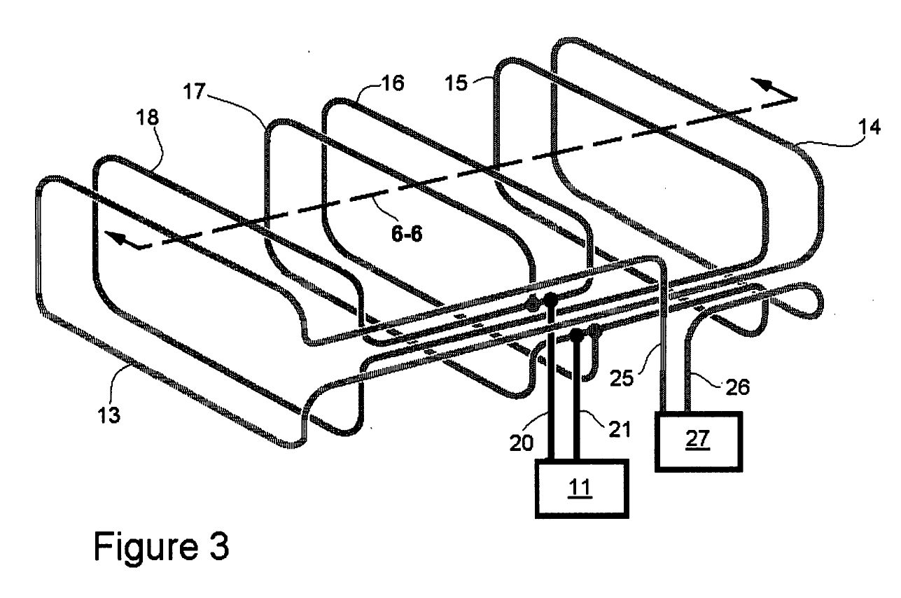

An oscillator coil assembly 10 resides within the cabinet 2. The oscillator coil assembly 10 surrounds and substantially bisects the cavity 7. As seen in FIG. 3, for example, the oscillator coil assembly 10 is excited or driven by a radio frequency oscillator or transmitter 11, which is housed within the region 12 of cabinet 2. Symmetrically spaced on opposite sides of oscillator coil assembly 10 is a front input coil 13 and a rear input coil 14. Coils 13 and 14 are connected to each other in series opposition.

The oscillator 11 produces a low frequency magnetic signal typically in the range of thirty kilohertz to two megahertz. The oscillator 11 is coupled to the oscillator coil 10 through leads 20 and 21. The oscillator coil 10 acts as an antenna, radiating the signal produced by oscillator 11 and producing a magnetic field within and somewhat beyond cavity 7. The input coils 13 and 14 reside within the magnetic field produced by the oscillator coil assembly 10.

In the absence of a metal contaminant 35, and due to their series opposition interconnection, the signal induced in the front coil 13 from oscillator coil assembly 10 is of the same magnitude but of opposite polarity as the signal induced in the rear coil 14, thereby producing a resultant signal of zero volts. When metal is present, or due to small irregularities in the position of coils 13 and 14, or the location of the case 2, or the presence of contaminant metal 35, the symmetry of the magnetic field produced by oscillator coil assembly 10 is distorted, thereby causing signals of different magnitude to appear on coils 13 and 14. This imbalance produces a signal having a magnitude that is greater than zero volts.

The strength of the signal produced by the input coils 13 and 14 is a function of the size, shape and composition of the coils 13 and 14, the absolute strength of the magnetic field produced by oscillator coil assembly 10, the size of the metal object 35, the composition of the metal object 35, the distance between the metal object 35 and the input coils 13 and 14, and the distance of the metal object 35 from the oscillator coil assembly 10. The closer the metal object is to the oscillator coil assembly 10, the greater will be the distortion of the magnetic field created by oscillator coil assembly 10. A relatively greater field distortion appearing on one input coil produces a relatively greater unbalance in the signals induced by the combination of the input coils 13 and 14. Similarly, the closer the metal object 35 is to either receiver coil 13 or 14, the greater the imbalance in the amount of signal induced in either coil. Thus, a greater distance between the metal object 35 and any of the coils 10, 13 or 14 reduces the magnitude of the unbalanced signal. Typically, the input coils 13 and 14 are arranged and spaced in such a manner so as to maximize the magnitude of the unbalanced signal when the metal object is passed through the center of the cavity 7.

The oscillator 11 operates at a discrete, continuous wave radio frequency typically in the range of 0.030 to 2.00 megahertz. The magnetic field emitted by oscillator coil assembly 10 is coupled to the adjacent input coils 13 and 14 by magnetic induction creating signals in both coils 13 and 14. Since the coils 13 and 14 are wired in series opposition, there is no resultant output signal when metal 35 or other electromagnetic field distorting medium is absent from the vicinity of the emitted magnetic field.

Referring also to FIG. 9, when a moving metal article 35 is brought into proximity with the radiated magnetic field of the oscillator coil assembly 10, the magnetic field effectively undergoes amplitude and phase modulation, that is, the magnetic field density varies with respect to time. The modulation frequency is typically in the range of 0.10 to 100 hertz. The amplitude of the modulation is dependent on the size and speed of the metal 35 or product 54 passing through the aperture 6 as well as the coil separation.

The signal 8 received by input coil 13, for example, will have an amplitude and an amplitude modulation frequency that is dependent on the metal or product characteristics as well as the velocity of the metal as it passes through the detector cavity 7. The signal waveform 8 depicts the change in voltage across the input coil 13 when metal passes by the coil. The change in voltage is of the order of a few tens of nanovolts for a small contaminant 35 superimposed on a standing voltage of up to ten volts. The standing voltage is the same on each coil 13 and 14. By wiring the coils 13 and 14 in an anti-phase relationship, the relatively large standing voltage is removed. The axis 46 represents the magnitude or amplitude of the signal 8 in units such as volts, while axis 47 represents the distance traveled or horizontal displacement of the metal contaminant 35.

The point 48 of signal 8 represents a point in time when no metal or product is in the detector cavity 7. The signal 8 is representative of the signal appearing on one input coil 13, which remains the same regardless of the signal on the other input coil 14. As metal 35 enters the location in the detector cavity 7 and approaches the first input coil 13, the magnitude of signal 8 changes and has an amplitude modulation envelope peak 50 which corresponds to the metal object passing between oscillator coil and the input coil 13. Signal 24 represents a second amplitude modulation envelope peak 49 which corresponds to the metal object passing between oscillator coil and the input coil 14. The time difference between the envelope peaks 50 and 49 along axis 47 indicates the absolute frequency of the amplitude modulation, which is dependent on the parameters such as the speed and size of the contaminant 35. The closer the input coils 13 and 14 are to the center of the cavity 7, and hence to the oscillator coil assembly 10 which resides at or near the center of the cavity 7, the higher the frequency of the amplitude modulation due to the shorter period of time needed for passage of the object over the input coils 13 and 14.

If metal 35 resides at the aperture center 51, the magnitude of the voltage induced in each input coil 13 and 14 will be substantially equal, corresponding to the magnitude of, for example, point 52. Similarly, if the metal object 35 is nearer to input coil 13, the magnitude 53 of the voltage induced in coil 13 is greater than the magnitude 23 of the voltage induced in coil 14 at the same moment. In other words, the magnitude of the voltage induced in the nearer coil is measurably greater than the voltage induced in the more distant coil. Only metal residing in the center 20 of the cavity 7 will produce a ratio of voltages in input coils 13 and 14 that is approximately 1:1.

By monitoring the ratio of the voltages 8 and 24 induced in each coil, respectively, at the same instant, the position of the metal within the cavity can be calculated. A recognition that the signal produced on the input coils 13, 14 is the result of metal located within the cavity permits signals not corresponding to an in cavity location to be excluded as either the result of vibration or attributable to metal external to the metal detector 1. By monitoring the position of the each contaminant using the ratio method just described, the position of a second contaminant can be determined and its effect on the signal attributable to the first contaminant can be recognized.

The oscillator 11 is capable of delivering a current of approximately 11 amperes root mean square (11 A RMS). When the oscillator coil assembly 10 surrounds an aperture 6 having dimensions of, for example, 350 mm by 150 mm, the coil inductance limits the actual coil current to 7.5 A RMS at 300 kHz because the peak to peak voltage from the oscillator is also limited, in this case to 40 v. An aperture size of 600 mm by 200 mm will create a current of only 3 A, which represents a significant reduction in radiated magnetic flux from that which is theoretically available from the oscillator coil assembly 10.

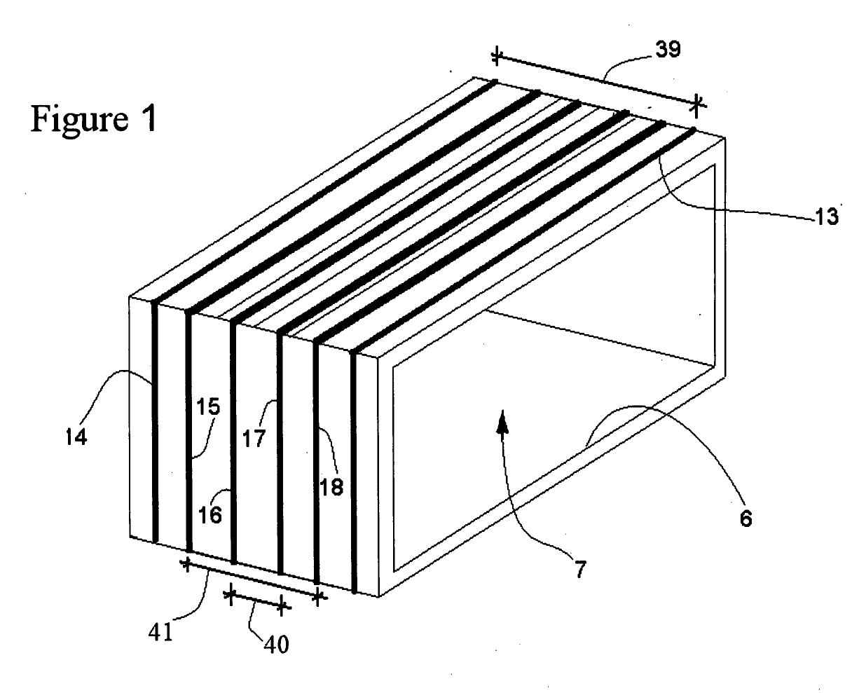

Referring also to FIG. 1, a first improved oscillator coil arrangement can be understood. The oscillator coil assembly 10 is composed of several separate coils 15, 16, 17 and 18. Thus, the coil assembly 10 spans the entire region 41. While four coils are shown residing within coil assembly 10, more than four coils may be used in alternate embodiments of the present invention. In one version of the present invention, the input coils 13 and 14 define the boundaries of a region 39 within which the region 41, occupied by individual coils 15-18 of coil assembly 10, resides. In other configurations, the input coils 13 and 14 reside inboard of the outermost oscillator coils 15 and 18.

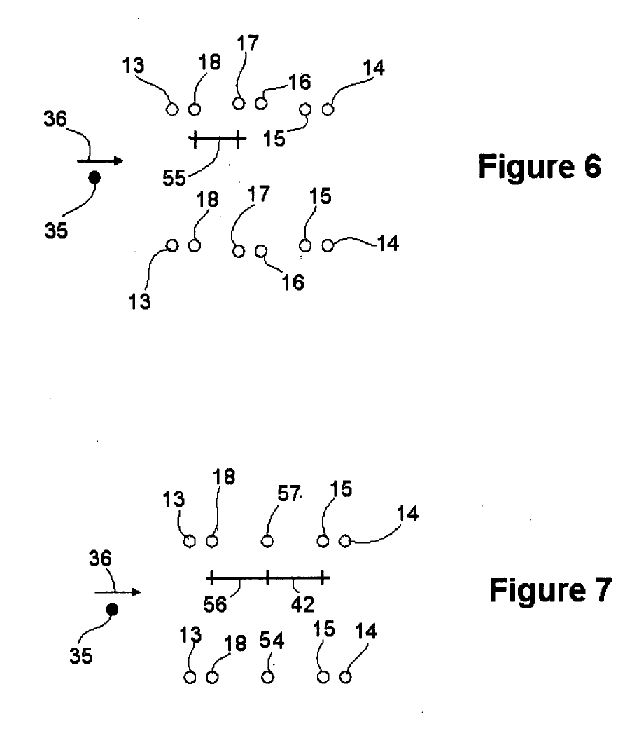

Referring also to FIGS. 3 and 6, two separate sets of oscillator coils are depicted. The first set of oscillator coils is composed of coils 16 and 17 which are seen in FIG. 3 to be interconnected in an electrically parallel relationship. Spaced apart from the coil 16 is the coil 15, while coil 18 is separated from coil 17 by distance 55. The coils 15 and 18 form a second set of oscillator coils that are interconnected in an electrically series relationship. The series coils 15 and 18 may be wound in either an in phase or antiphase relationship. In either case both sets of oscillator coils reside between the input coils 13 and 14.

The inner set of oscillator coils 16, 17 are in parallel and the outer set of coils 15, 18 are in series. The inner set of coils 16 and 17 may be wound in either an in phase or antiphase relationship. Such an arrangement is particularly advantageous for relatively larger coil assemblies 10 and results in the creation of increased signal levels. All of the coils 15-18 are interconnected to the oscillator 11 by leads 20 and 21. In an alternate embodiment of the present invention the parallel coils 16, 17 are excited by a first oscillator and the series coil 15, 18 are excited by a second oscillator. The two oscillators can operate at different frequencies and at differing power levels. Each of the input coils 13 and 14 are interconnected to receiver 27 by leads 25 and 26. In another embodiment of the present invention, the coils 15 and 18 are omitted, leaving a pair of parallel interconnected oscillator coil 16 and 17. The coils 16 and 17 can be interconnected in either an in phase or antiphase relationship.

The two series oscillator coils 15 and 18 are spaced apart a sufficient distance 41 to permit the generation of largely separate magnetic fields. The input coils 13 and 14 reside outside of the volume defined by the series oscillator coils 15 and 18 as well as the parallel oscillator coils 16 and 17, the input coils being connected to input signal processing circuitry 27. The optimum spacing 40 between coils 16 and 17 is approximately half the distance 55 between the oscillator coils 17 and 18. The two oscillator coils 16 and 17 are wound in parallel to create a twin coil which is fed by oscillator leads 20 and 21. The coils 16 and 17 may be arranged so that their fields are either additive or in phase opposition. The total current drawn by the combined twin coils 16 and 17 is substantially greater than a single coil having the same dimensions. For an aperture size of 600 mm by 200 mm, the current increases from approximately 3 A for a single coil to approximately 5 A for the twin coil 31.

The radiated magnetic flux is directly proportional to the current drain, the increased flux thereby causing the absolute magnitude of the peak signals 49 and 50 to increase, thereby simplifying their detection and measurement. Further, because each input coil 13 and 14 is physically closer to its adjacent oscillator coil 15 and 18, respectively, the signal to noise ratio is further improved. In theory, the overall net gain achieved with the combination of the series coils 16 and 17 with the parallel coils 16 and 17 is substantially greater than a single oscillator coil configuration. This gain improvement translates into detection of metal particles that are approximately 25% smaller. Table I compares the expected performance of the present arrangement of combined series and parallel coils with the previous single oscillator coil method for an actual metal detector.

TABLE I
300 kHz Peak Signal Test

| | | Combined | |
|---|---|---|---|
| | | Series and | Combined Series |
| | | Parallel | and Parallel Coils |
| | Single Coil | Coils Peak | Peak Signal |
| Test sample | Peak Signal | Signal | Improvement |
| 0.8 mm Fe | 140 | 290 | 2.07 |
| 0.8 mm NFe | 165 | 320 | 1.94 |
| 1.2 mm SS | 143 | 275 | 1.92 |
| 1.5 mm SS | 435 | 805 | 1.85 |

| | |
|---|---|
| Average Improvement | 1.95 (+95%) |

Table I shows that the peak signal reading produced by the combination of dual parallel and series interconnected oscillator coils produces significantly higher peak detector readings. In particular, the improvement afforded by the multiple coil system of the present invention shows an average improvement factor of 1.95 for a variety of potential metal contaminants 35.

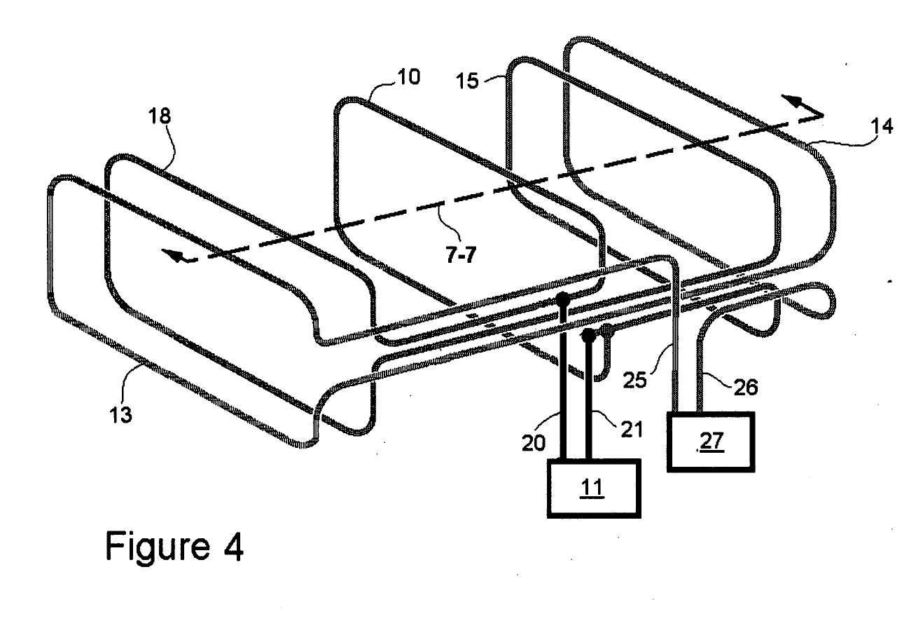

Referring also to FIGS. 4 and 7, a second improved oscillator coil configuration can be understood. An oscillator coil assembly 10 of intermediate size may have dimensions of approximately 350 by 150 mm such as would be associated with an intermediate sized aperture. A single coil will have a relatively intermediate value of inductance which will benefit from an inductance enhancement. In such a case, the single oscillator coil 57 is placed between two additional coils 15 and 18 which are interconnected in series. The series coils 15 and 18 are symmetrically spaced so as to be relatively close to the nearest input coil 14 and 13, respectively. In other words the distances 42 and 56 are approximately equal and greater than the spacing between oscillator coil 15 and input coil 14. Both the single coil 57 and the two series coils 15 and 18 are excited from the same voltage source 11 although they may be driven at different voltage levels. The coils 57, 15 and 18 may be wound in either an in phase or antiphase relationship.

For relatively smaller aperture sizes, the small inductance value produced by a single oscillator coil necessarily means that the oscillator coil will draw a relatively greater current. Since the oscillator 11 typically cannot deliver more than 11 A RMS, the driving voltage delivered by the oscillator 11 to the oscillator coil must be limited in order to prevent excessive current demand. A typical standard sized oscillator coil may have a potential difference of 40 volts peak to peak (40 Vp-p), whereas a smaller dimensioned oscillator coil may permit an oscillator voltage of only 10 Vp-p.

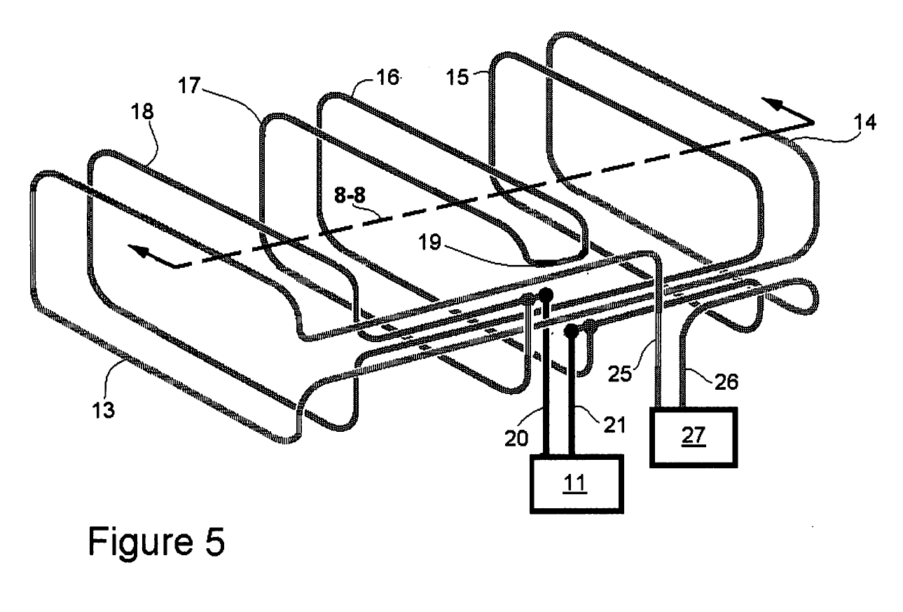

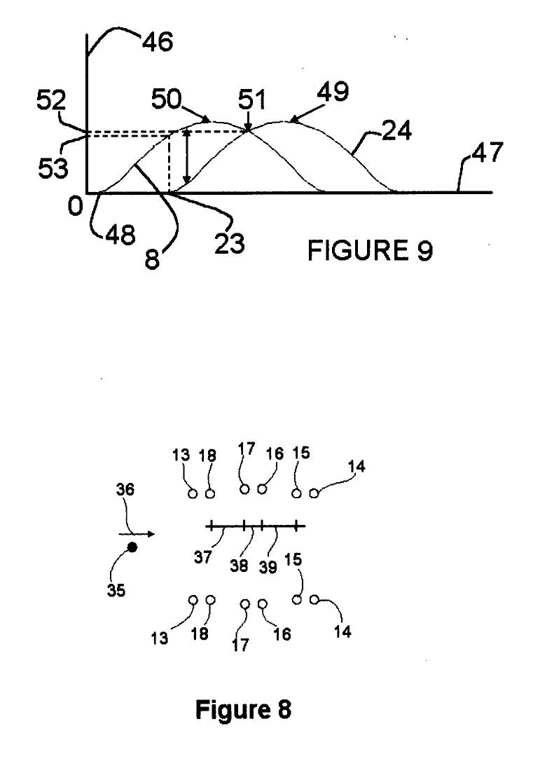

Referring also to FIGS. 5 and 8, the improved oscillator coil assembly 10 is constructed to address the inherent shortcomings of a relatively smaller search head and includes two sets of series wound oscillator coils 16, 17 and 15, 18. The adjacent oscillator coils 16 and 17 are interconnected at region 19 to create an electrically series relationship. The coils 16 and 17 may be arranged so that their fields are either additive or in phase opposition. The typical theoretical improvement in the radiated magnetic flux is approximately 4:1, which increases to approximately 5:1 if the coils 16 and 17 are placed such that the ratio of distance 38 to distances 37 or 39 is relatively small. Altematively, for a given voltage, the current can be reduced by a factor of 5:1 if the original level of magnetic flux is to be maintained. However, since the current drain has been reduced by a factor of five, the voltage produced by oscillator 11 can be increase by a factor of five without exceeding the maximum permissible current drain, thereby permitting an increase of 5:1 in the radiated magnetic flux. In practice, the actual improvement in magnetic flux is often limited to about 3:1 due to the proximity of the case 2.

The two oscillator coils 18 and 15 are spaced so as to be relatively closer to their adjacent input coil 13 and 14, respectively. This increased spacing between the oscillator coils 15 and 18 causes each oscillator coil 18 and 15 to act substantially independently and behave as two inductors in a series circuit. The net inductance increase is therefore 2:1 which corresponds to a doubling of the radiated magnetic flux when the voltage of oscillator 11 is doubled. However, a metal object passing close to input coil 13, for example and its associated oscillator coil 18 will cause a minute change in the oscillator voltage across coil 18. The change in oscillator voltage causes a corresponding change in the magnitude of the current drawn from the oscillator 11, the change being perceived or forwarded to the other oscillator coil 15 since the two coils 18 and 15 are wound in series. The result of the voltage and current change is to produce an additive signal which creates a potential flux improvement of approximately 2.5:1. A radiated flux improvement of 2.5:1 corresponds to a decrease in size of the minimum detectable contaminant of approximately 35%.

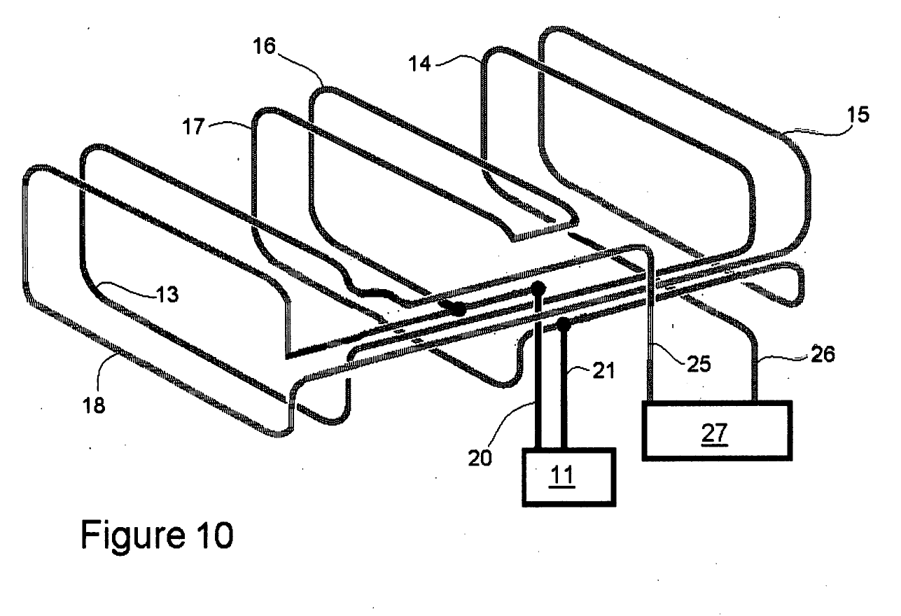

The foregoing improvements embodied in the present invention are by way of example only. Those skilled in the metal detecting field will appreciate that the foregoing features may be modified as appropriate for various specific applications without departing from the scope of the claims. For example, as illustrated in FIG. 10, the input coils 13 and 14 reside between the outermost series oscillator coils 15 and 18, wound in an antiphase relationship, and the innermost series oscillator coils 16 and 17.

I claim:

1. A metal detector, comprising:
(a) a radio frequency oscillator;
(b) an oscillator coil assembly, the coil assembly being electrically interconnected to the oscillator so as to emit a magnetic field in a region surrounding the oscillator coil assembly, the oscillator coil assembly being constructed of at least three individual coils.
(c) a first input coil residing within the magnetic field, the first input coil generating a first signal in response to a disturbance of the magnetic field;
(d) a second input coil residing within the magnetic field, the second input coil generating a second signal in response to a disturbance of the magnetic field; and
(e) a signal processor, the signal processor measuring a ratio of the first signal and the second signal so as to determine a physical location of an item causing the disturbance of the magnetic field.

2. The metal detector according to claim 1, wherein the signal processor records a first peak attributable to the first signal and the signal processor records a second peak attributable to the second signal, the signal processor determining a direction of travel of the item causing the disturbance of the magnetic field.

3. The apparatus according to claim 1, wherein the metal detector further comprises:
(a) a case, the case housing the oscillator, the oscillator coil assembly, the first and second input coils, and the signal processor;
(b) a cavity, the cavity residing within the case, the cavity being dimensioned to house a product while being examined for metal contaminants;
(c) a first aperture formed within the case and permitting the product to enter the cavity;
(d) a second cavity, the second cavity being formed within the case and permitting the product to exit the cavity; and
(e) a conveyor, the conveyor transporting the product through the cavity.

4. An apparatus according to claim 1, wherein the signal processor associates a disturbance of the magnetic field with a metallic item when the item is determined to reside within the cavity.

5. An apparatus according to claim 1, wherein the signal processor excludes as a potential metallic contaminant an item causing a disturbance of the magnetic field when the disturbance is attributable to a metallic item residing outside of the cavity.

6. An apparatus according to claim 5, wherein the oscillator coil assembly further comprises;
(a) a single oscillator coil residing in a central region of the cavity; and
(b) first and second series interconnected coils, the single oscillator coil residing between the first and second series interconnected coils.

7. The apparatus of claim 5, wherein the oscillator coil assembly further comprises:
(a) a pair of parallel interconnected oscillator coils residing in a central region of the cavity; and
(b) first and second series interconnected coils, the pair of parallel interconnected oscillator coils residing between the first and second series interconnected coils.

8. The apparatus of claim 5, wherein the oscillator coil assembly further comprises:
(a) a first pair of series interconnected oscillator coils residing in a central region of the cavity; and
(b) a second pair of series interconnected coils, the first pair of series interconnected oscillator coils residing between the second pair of series interconnected coils.

9. The apparatus of claim 1, wherein the oscillator coil assembly is formed to include a pair of electrically parallel oscillator coils connected in phase.

10. The apparatus of claim 5, wherein the oscillator coil assembly further comprises:
(a) a pair of parallel interconnected oscillator coils residing in a central region of the cavity; and
(b) first and second series interconnected coils, the pair of parallel interconnected oscillator coils residing between the first and second series interconnected coils; and
(c) third and fourth series interconnected coils, the third series interconnected coil residing between the first series interconnected coil and the first input coil.

11. A metal detector providing increased magnetic flux for a fixed aperture area, comprising:
(a) an oscillator;
(b) an oscillator coil assembly, the coil assembly being electrically interconnected to the oscillator so as to emit a magnetic field in a region surrounding the oscillator coil, the oscillator coil assembly including at least three separate coils;
(c) a first input coil residing within the magnetic field, the first input coil generating a first signal in response to a disturbance of the magnetic field;
(d) a second input coil residing within the magnetic field, the second input coil generating a second signal in response to a disturbance of the magnetic field; and
(e) an input coil voltage monitor, the voltage monitor being electrically interconnected to the first and second input coils, the voltage monitor calculating an instantaneous ratio between a voltage amplitude of the first signal and a voltage amplitude of the second signal so as to determine a physical location of an item causing a disturbance of the magnetic field.

12. A method of detecting metal, comprising the steps of:
(a) radiating an magnetic field;
(b) simultaneously monitoring a voltage induced by a disturbance of the magnetic field from a first position and a second position; and
(c) calculating a ratio of voltage measured at the first position and the second position; and
(d) determining a location of an item causing the disturbance of the magnetic field based on the ratio of current at each location.

13. The method of claim 12, further comprising the steps of:
(a) placing a product under test within a cavity;
(b) determining if the item causing the disturbance to the magnetic field is located within the cavity; and
(c) categorizing the item as a metallic contaminant when the item is located within the cavity.

14. The method of claim 13, further comprising the steps of:
(a) placing an oscillator coil assembly so as to surround the cavity; and
(b) placing a first and second input coil so as to surround the cavity such that the oscillator coil assembly resides between the first and second input coil.

15. The method of claim 14, further comprising the steps of:
(a) forming the oscillator coil assembly so as to include a first oscillator coil formed as a single loop; and
(b) forming second and third oscillator coils such that the first oscillator coil resides between the second and third oscillator coils.

16. The method of claim 15 further comprising the step of interconnecting the second and third oscillator coils in an electrically series relationship.

17. The method of claim 14, further comprising the steps of:
(a) forming the oscillator coil assembly to include a first pair of oscillator coils interconnected in an electrically parallel relationship; and
(b) forming a second pair of oscillator coils interconnected in an electrical series relationship such that the first pair of oscillator coils resides between the second pair of oscillator coils.

18. The method of claim 14, further comprising the steps of:
(a) forming the oscillator coil assembly to include a first pair of oscillator coils interconnected in an electrically series relationship; and
(b) forming a second pair of oscillator coils interconnected in an electrically parallel relationship such that the first pair of oscillator coils resides between the second pair of oscillator coils.

19. The method of claim 18, further comprising the step of
forming the oscillator coil assembly to include a third pair of oscillator coils interconnected in an electrically series relationship such that the second pair of oscillator coils resides between the third pair of oscillator coils.

20. The method of claim 13, further comprising the steps of:
(a) placing an oscillator coil assembly so as to surround the cavity;
(b) placing a first pair of series wound oscillator coils within the oscillator coil assembly;
(c) placing a first and second input coil so as to surround the cavity such that the oscillator coil assembly resides between the first and second input coil;
(d) placing a second pair of spaced apart series wound oscillator coils so as to surround the cavity and so as to reside apart from the oscillator coil assembly, the first and second input coils residing between the second pair of spaced apart series wound oscillator coils.
